(19) United States
(12) Patent Application Publication
(10) Pub. No.: US 2026/0183796 A1
(43) Pub. Date: Jul. 2, 2026

(54) Agricultural Feed Particle Separator for Field Use

(71) Applicant: Meyers Manufacturing Corporation, Dorchester, WI (US)

(72) Inventors: Chris Albright, Hazelhurst, WI (US); Brandon J. Boor, Athens, WI (US); James Kappel, Junction City, WI (US)

(21) Appl. No.: 19/007,908

(22) Filed: Jan. 2, 2025

(51) Int. Cl. B07B 1/36; A01K 5/02; B07B 1/42; B07B 1/46

(52) U.S. Cl. CPC B07B 1/36; A01K 5/02; B07B 1/42; B07B 1/46; B07B 2201/04

(57) ABSTRACT

An agricultural feed particle separator adapted for field use provides a portable unit with a fully sealable shaker box allowing viewing of the process through an upper window. Equal tare weights of the drawers of the shaker box and or the built-in load sensing system eliminates the loss of material in field conditions that can occur during transfer of feed material from drawers into separate containers for transport. In some embodiments each of the drawers may have a matching tare weight.

### STATEMENT REGARDING FEDERALLY SPONSORED RESEARCH OR DEVELOPMENT

### CROSS REFERENCE TO RELATED APPLICATION

### BACKGROUND OF THE INVENTION

The present invention relates generally to an apparatus and method for assessing particle sizes for ruminant feed and, in particular, to an apparatus providing improved field assessment.

The particle size distribution of forage for dairy cows and other animals is important for assessing the nutritional value of the forage. The American Society of Agricultural and Biological Engineers (ASABE) has developed a machine for such an assessment employing multiple sequentially finer sieves through which forage falls while the sieves are being shaken.

In use, samples of forage are transported to a central location and measured using this machine to help assess the forage nutritional value.

### SUMMARY OF THE INVENTION

The present provides a portable and rapid field forage tester greatly reducing errors from moisture and material loss during material transport to a central location, while providing for more immediate results. In this regard, the invention provides a lightweight and motorized particle separator transportable to forage locations, for example, as supported on the bed of a pickup truck. A set of sieves are fully contained inside a housing during shaking preventing loss of material possible with this smaller form factor when used outdoors and in possibly windy conditions. The progress of the sifting within the housing may be visible through a window to the upper chamber again without opening the device. Built in weight sensing allows material amounts to be measured without exposing the drawer contents to wind or the like such as may carry away finer materials. A reduced number of three sieves further decreases the size and weight of the separator, increasing its portability and usability. Immediate remote sensing and reporting prevents loss of data or inaccuracies in recording that can occur in the field.

More specifically, in one embodiment, the invention provides an agricultural feed particle separator having a support frame, a shaker housing, and a motor and a communicating shaker linkage. The shaker linkage supports the shaker housing on the support frame to shake the shaker housing in two horizontal directions with activation of the motor. A set of drawers is positionable in a vertical stack within the shaker housing, with the top two drawers having sieve bottoms with successively smaller aperture sizes. A drawer retainer is closable over a side surface of the shaker housing through which the set of drawers may be removably inserted to provide an enclosed volume within the shaker housing.

It is thus a feature of at least one embodiment of the invention to provide a particle separator that can be used in the field with reduced loss of material and moisture associated with transporting samples.

The portable agricultural feed particle separator may further include a set of weight sensors communicating with the shaker housing to support the set of drawers, the weight sensors providing an electronic weight measure of each of the set of drawers, the weight sensors having an axis of sensitivity perpendicular to the two horizontal directions.

It is thus a feature of at least one embodiment of the invention to provide a particle feed separator that can be used in the field and possibly windy conditions without the loss of material associated with removing the drawers and transferring the material into containers for future measurement.

The portable agricultural feed particle separator may further include an electronic controller holding a tare weight table indicating a tare weight of the set of drawers and subtracting the tare weight from the electronic weight measure to provide a set of outputs indicating retained material in each drawer.

It is thus a feature of at least one embodiment of the invention to eliminate the weight of the drawers in the measurement of feed material and thus the need to transfer the feed material out of the drawers during the measurement process.

The portable agricultural feed particle separator may further include a window in an upper wall of the shaker housing allowing viewing of the contents of an uppermost drawer of the set of drawers through the window when the uppermost drawer is within the shaker housing.

It is thus a feature of at least one embodiment of the invention to allow monitoring of the material without exposing the material to wind by opening of the shaker housing.

The window may be within a housing lid closable over an upper opening of the shaker housing through which material may be introduced into an uppermost drawer when the uppermost drawer is within the shaker housing.

It is thus a feature of at least one embodiment of the invention to allow ready loading of forage into the top sieve drawer to simplify the measurement process by allowing the drawers to be preinstalled prior to forage introduction.

The shaker linkage may include a crank arm driven by the motor and attached at a first pivot point to a bottom of the shaker housing and a slide movable along the support frame and attached at a second pivot point to a bottom of the shaker housing.

It is thus a feature of at least one embodiment of the invention to provide a simple mechanism that may employ as few as one motor to provide shaking along two perpendicular axes.

The agricultural feed particle separator may further include rolling element bearings positioned between the bottom of the shaker housing and the shaker linkage for each of the pivot points in between the slide and the support frame.

It is thus a feature of at least one embodiment of the invention to minimize frictional losses to allow operation with low-power electricity in the field, for example, from a truck battery or the like.

The set of drawers may be limited to three drawers with a lowermost drawer having a solid bottom.

It is thus a feature of at least one embodiment of the invention to minimize the size and weight of the particle separator for portable field use.

Each of the sieve drawers may have a matching tare weight.

It is thus a feature of at least one embodiment of the invention to eliminate the time-consuming step of determining and tracking a tare weight for each sifter.

These particular objects and advantages may apply to only some embodiments falling within the claims and thus do not define the scope of the invention.

### BRIEF DESCRIPTION OF THE DRAWINGS

FIG. 1 is a perspective view of a separator according to one embodiment of the invention showing a shaker housing with an open front door and upper lid, the former having an observation window and the latter providing access to sieve drawers having removable bottom separators, the shaker housing supported on a slide frame;

FIG. 2 is a simplified exploded perspective view of the sieve drawers and slides showing the gradation in sieve opening size;

FIG. 3 is a detail fragment in perspective of the lower edge of a sieve drawer showing receipt of the slide separator;

FIGS. 4a-4d are set of simplified top plan views of the separator with the shaker housing in phantom showing the single motor providing multi-axis reciprocating motion of the shaker housing; and

FIG. 5 is a schematic diagram of one embodiment of the invention providing an integrated scale system.

### DETAILED DESCRIPTION OF THE PREFERRED EMBODIMENT

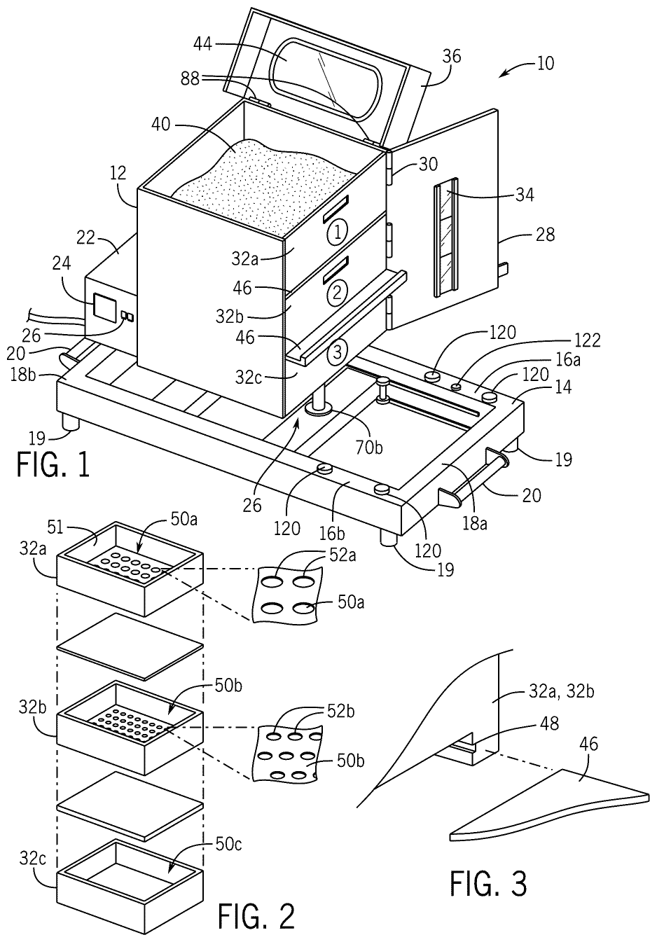

Referring now to FIG. 1, an agricultural particle separator 10 per the present invention may provide for a box-shaped shaker housing 12 movably supported on a frame 14. The frame 14 may be constructed, for example, of side rails 16a and 16b held in parallel separation at opposite end rails 18a and 18b in the form of a rectangle. Adjustable leveler feet 19 positioned at corners of the frame 14 allow the frame 14 to be leveled on a supporting surface, for example, by screw mechanisms changing the downward extension of the leveler feet 19 from the bottom surface of the frame 14.

Each end rail 18 of the frame 14 may support a horizontally and outwardly extending handle 20 allowing the agricultural particle separator 10 to be readily moved or repositioned, facilitated by a light weight of the agricultural particle separator 10 of less than 80 pounds.

The frame 14 supports a motor unit 22 having an optional display 24 and selector keypad 25 provided for automated controls of the agricultural particle separator 10, in some configurations, as will be discussed below. The motor unit 22 generally provides an electric motor that communicates with a linkage (to be discussed further below) which supports the shaker housing 12 to move the shaker housing 12 in two perpendicular directions to promote particle separation.

The shaker housing 12 may provide a front housing door 28, for example, pivoting open on a set of hinges 30 along one vertical edge of the door 28 to reveal a set of collector drawers 32a, 32b, and 32c. These collector drawers 32 are aligned vertically within the shaker housing 12 and may be individually removed from the shaker housing by sliding them horizontally out of the open housing door 28 along individual rails (not shown). When the collector drawers 32 are installed in the shaker housing 12, the front housing door 28 may close and latched at once, operating to seal the collector drawers 32 within an enclosed volume of the shaker housing 12 and prevent independent movement (rattling) within the volume during the shaking process. For this purpose, a door stiffener rib 34 on an inner surface of the front housing door 28 may abut front edges of the drawers 32 when the door 28 is closed to prevent shifting of the drawers 32 with respect to the shaker housing 12 when the front housing doors are closed.

The shaker housing 12 may also provide for an upper lid 36 pivoting on hinges 38 along one horizontal upper edge of the shaker housing 12 to open and reveal the upper drawer 32a. The upper lid 36 may be opened for the introduction of forage 40 into the upper drawer 32a and then closed and latched operating together with the front housing door 28 to seal the collector drawers 32 within the enclosed volume of the shaker housing 12 during the shaking process. A window 44 positioned on the upper lid 36 allows viewing of the forage 40 during the shaking process without risk of forage escaping or being blown by wind.

Referring also to FIG. 3, positioned between drawers 32a and 32b and between drawers 32b and 32c are optional planar sheet separators 46 whose left and right edges may slidingly engage opposed horizontal grooves 48 at bottom sidewalls of the drawer (32a or 32b) to cover sieve openings in those drawers 32, as will be discussed, blocking the egress of material from the drawer 32 when the drawer 32 is removed from the shaker housing 12. These separators 46 can be installed or removed from the drawers 32 when the drawers 32 are in the shaker housing 12 and the housing door 28 is open. Generally, the separators 46 will be removed during a shaking of the shaker housing 12 that occurs during separation of the forage 40 into the drawers 32, as will be described, and then reinserted in the corresponding drawers 32 prior to removal of the drawers 32 for weighing.

Referring now to FIG. 2, the top two drawers 32a and 32b may have sieve bottoms 50a and 50b having different size openings 52a and 52b. In one embodiment, the openings 52a may have a diameter of 0.75 inches and be circular, and opening 52b may have a diameter of 0.31 inches and also be circular. Drawer 32c will have a continuous bottom surface 50c without openings.

Each of the drawers 32 and sheet separators 42 will have operatively identical weights, meaning that differences in weight between drawers 32 or between separators 42 will be less than the desired tolerances of the measurements of forage 40 so that the forage 40 can be weighed by placing the drawers 32 sequentially on a scale without needing to change the tare weight between each measurement. This equalization of weight may be implemented by removal of material from the drawers 32, for example, by drilling holes in a sidewall to selectively bring them into a comparable weight or by attachment of weights 51 thereby compensating for variations in the amount of material of the drawers caused by the varying hole sizes (or lack of holes) in the sieve bottoms 50a and 50b and solid bottom 50c.

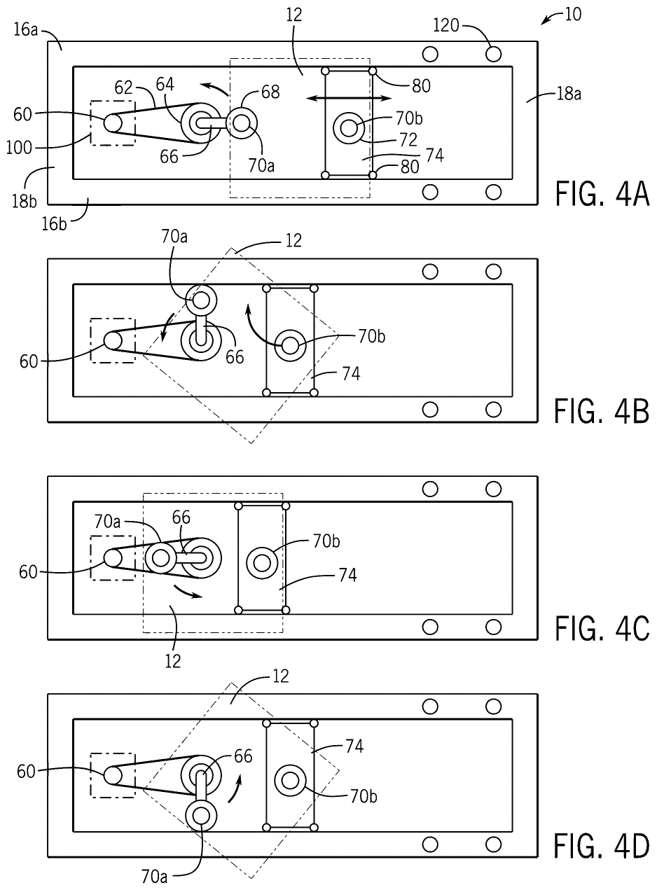

Referring now to FIGS. 4a-4c, the motor unit 22 may have a downwardly extending rotating shaft 60 connected by a belt 62 to a reducer wheel 64 spaced horizontally from the shaft 60. The reducer wheel 64 in turn rotates a crank arm 66 within a horizontal plane. A distal end of the crank arm 66 provides a shaft extending upwardly to pivotably attach to a bottom rear of the shaker housing 12 via a bearing journal 68 at a first pivot point 70a. A second pivot point 70b at a bottom front of the shaker housing 12 is provided by a second downwardly extending shaft pivoting via a bearing journal 72 and attached to a slider 74 positioned below the shaker housing 12. Generally the bearing journals 68 and 72 will provide “rolling element” bearings such as ball bearings, roller bearings, needle bearings or the like.

The slider 74 attaches to the inner surfaces of the rails 16a and 16b by linear slide bearings 80 to provide track-guided linear motion along the rails 16. These linear slide bearings 80 may also use rolling elements, such as ball bearings, needle bearings, roller bearings or the like.

As depicted in FIGS. 4a-4d, rotation of the motor shaft 60 causes a reciprocating and oscillating motion of the shaker housing 12 in two directions in a horizontal plane, allowing the forage material to slide over the surface of the sieve bottoms 50a and 50b as it passes downwardly through the drawers to be separated thereby. The bearings of bearing journals 68 and 72 and linear slide bearings 80 and compact size of the agricultural particle separator 10 allow this action to be performed with a low-power motor unit 22 readily operated on power from a truck battery or the like.

It will be appreciated that the above describe structure may be enclosed within an outer housing shielding users from any moving mechanisms. Generally, the above-described mechanism will have a weight of less than 250 pounds and desirably less than 200 pounds to be readily moved in the field, for example, in a pickup truck. For this purpose, the mechanism will generally fit within a 3′×3′ perimeter.

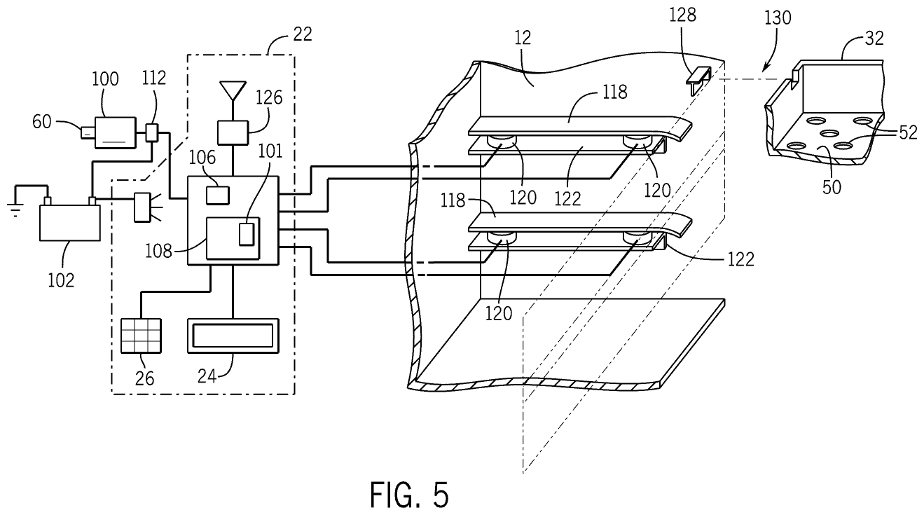

Referring now to FIGS. 1 and 5, the motor unit 22 may employ an electric motor 100, for example, a fractional horsepower DC motor, that may be powered using the power of a truck battery 102 or up converted 110 V. A controller 104, for example, having a processor 106 and electronic memory 108 storing a stored program 110, may provide for control of the motor 100, for example, through a relay 112 to implement a timer function controlling operation of the motor 100 for a fixed time period as initiated and set in duration by keypad 26. The display 24 may indicate total time and elapsed time during this process.

In one embodiment, the inner walls of the shaker housing 12 may provide for drawer glides 118 supporting bottoms of the drawers 32 when the drawers 32 are slid into the housing 12. The drawer glides 118 may be supported by load cells 120 which are in turn supported by brackets 122 fixed to opposite the inner walls of the shaker housing 12. The load cells 120 communicate with the controller 104 to allow the individual drawers 32 to be placed on the load cells 120 so that their weight can be determined after the sifting process without removing the drawers 32. The measurement axes of the load cells 120 will be perpendicular to the motion of the shaker housing 12 during use preventing undue forces from being applied to these elements. Alternatively or in addition, a locking mechanism (not shown) may be used to support the glides 118 above the load cells 120 during the shaking process or transportation.

In this regard, the controller 104 may display the indicated weight of each drawer after subtracting a known tare value (set to be constant during manufacture as discussed above or otherwise programmed in a lookup table associating each drawer with a tare weight) and may permit the calculation of various values such as weight ratios between the different drawers 32. These calculations including a date stamp and timestamp may be displayed on the display 24 and/or transmitted by means of a cell phone link 126 to a remote reporting terminal.

In order that the proper drawers 32 are installed on the proper glides 118, and in the correct sifting order, a ward tab 128 may be positioned in the opening of the housing 12 receiving the drawers 32 matching a corresponding notch 130 in the rear of the drawers 32 allowing only a single corresponding drawer to be placed in any given drawer opening.

Generally, the device described above may be used to perform measurements similar to those described in in Jud Heinrichs, The Penn State Particle Separator, available from the Penn State Cooperative extension of the College of Agricultural Sciences, hereby incorporated by reference.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

1. A portable agricultural feed particle separator comprising:
a support frame;
a shaker housing;
a motor and communicating shaker linkage, the shaker linkage supporting the shaker housing on the support frame to shake the shaker housing limited to two horizontal directions with activation of the motor;
a set of drawers positionable in a vertical stack within the shaker housing with a top two drawers having sieve bottoms with successively smaller aperture sizes; and
a door closable over a front surface of the shaker housing through which the set of drawers may be removably inserted, the door operating to cover and block forward removal of the drawers.

2. The portable agricultural feed particle separator of claim 1 further including a set of weight sensors communicating with the shaker housing to support the set of drawers, the weight sensors providing an electronic weight measure of each of the set of drawers, the weight sensors having an axis of sensitivity perpendicular to the two horizontal directions.

3. The portable agricultural feed particle separator of claim 2 further including an electronic controller holding a tare weight table indicating a tare weight of the set of drawers and subtracting the tare weight from the electronic weight measure to provide a set of outputs indicating retained material in each drawer.

4. The portable agricultural feed particle separator of claim 1 further including window in an upper wall of the shaker housing allowing viewing of contents of an uppermost drawer of the set of drawers through the window when the uppermost drawer is within the shaker housing.

5. The portable agricultural feed particle separator of claim 4 wherein the window is within a housing lid closable over an upper opening of the shaker housing through which material may be introduced into an uppermost drawer when the uppermost drawer is within the shaker housing.

6. The portable agricultural feed particle separator of claim 2 wherein each of the drawers has an equal tare weight.

7. The portable agricultural feed particle separator of claim 1 wherein each of the drawers provides a mechanical key so that the drawers may be inserted only in a single vertical order in the vertical stack.

8. The agricultural feed particle separator of claim 1 wherein the set of drawers is limited to three drawers with a lowermost drawer having a solid bottom.

9. The agricultural feed particle separator of claim 1 wherein the shaker linkage includes a crank arm driven by the motor and attached at a first pivot point to a bottom of the shaker housing and a slide movable along the support frame and attached at a second pivot point to a bottom of the shaker housing.

10. The agricultural feed particle separator of claim 9 further including rolling element bearings positioned between the bottom of the shaker housing and the shaker linkage for each of the pivot points in between the slide and the support frame.

11. A method of assessing agricultural feed employing a portable agricultural feed particle separator having:
a support frame;
a shaker housing;
a motor and communicating shaker linkage, the shaker linkage supporting the shaker housing on the support frame to shake the shaker housing in two horizontal directions with activation of the motor;
a set of drawers positionable in a vertical stack within the shaker housing with top two drawers having sieve bottoms with successively smaller aperture sizes;
a door closable over a front surface of the shaker housing through which the set of drawers may be removably inserted, the door operating to cover and block forward removal of the drawers; closure of the drawer retainer providing an enclosed volume within the shaker housing, the method comprising:
(a) transporting the portable agricultural feed particle separator to a feed material harvesting location;
(b) installing the set of drawers in the shaker housing and loading feed material into an upper drawer;
(c) activating the motor to shake the housing in two horizontal directions;
(d) determining a weight of the drawers after (c) to determine a net weight of feed material retained in each drawer.
